(19) United States
(12) Patent Application Publication
(10) Pub. No.: US 2021/0140851 A1
(43) Pub. Date: May 13, 2021

(54) SYSTEM AND METHOD FOR AUTOMATIC DIAGNOSIS OF POWER GENERATION FACILITY

(71) Applicant: KOREA ELECTRIC POWER CORPORATION, Naju-si (KR)

(72) Inventors: Yeon Whan KIM, Daejeon (KR); Dong Hwan KIM, 34056 (KR); Doo Young LEE, Daejeon (KR); Bum Soo KIM, Daejeon (KR); Jin Pyo HONG, Daejeon (KR); Joon Ha JUNG, Seoul (KR); Byung Chul JEON, Daegu (KR)

(21) Appl. No.: 16/611,450

(22) PCT Filed: Aug. 23, 2017
(86) PCT No.: PCT/KR2017/009221

§ 371 Date: Nov. 6, 2019

(30) Foreign Application Priority Data
May 12, 2017 (KR) 10-2017-0059157

(51) Int. Cl. G01M 15/14

(52) U.S. Cl. CPC G01M 15/14

(57) ABSTRACT

Disclosed are a system and a method for automatic diagnosis of a power generation facility, and a system for automatic diagnosis of a power generation facility which include a data measuring unit for acquiring vibration data from a rotating body of a power facility, a signal processing unit for signal-processing acquired vibration data, and extracting and quantifying predetermined characteristic factors with respect to a time domain, a frequency domain, and a shape area, a characteristic pattern storage unit for storing a characteristic factor pattern classified for each failure type, and a failure diagnosis unit for diagnosing whether a power facility to be diagnosed has a failure and a failure type of the power facility, on the basis of a classified characteristic factor pattern.

### CROSS-REFERENCE TO RELATED APPLICATIONS

This application is the National Stage filing under 35 U.S.C. 371 of International Application No. PCT/KR2017/009221, filed on Aug. 23, 2017, which claims the benefit of earlier filing date and right of priority to Korean Application No. 10-2017-0059157, filed on May 12, 2017, the contents of which are all hereby incorporated by reference herein in their entirety.

### TECHNICAL FIELD

The present disclosure relates to a system and method for automatic diagnosis of power generation facility.

### BACKGROUND ART

A reliable operation of the power supply is important because instability in the power supply causes great social and economic losses, but power generation facilities tend to gradually age and fail over time. Therefore, early diagnosis and efficient maintenance of the plant's abnormalities are required for safe management during the plant's operating period.

In the past, in the plant rotating body facilities (steam turbines, gas turbines, boiler water pumps, large fans, etc.), the vibration size of the rotating body was simply detected using the vibration monitoring system to determine if there was any abnormalities, but there were problems in that failure or direct cause of failure could not be determined on its own.

### DISCLOSURE

### Technical Problem

Therefore, an aspect of the detailed description is to provide a system and method for automatic diagnosis of power generation facility that can automatically determine failure and failure type from vibration signals of the rotating body of the power generation facilities, and can further predict abnormal conditions.

### Technical Solution

In order to accomplish the foregoing and other objects, according to an aspect of the present disclosure, an automatic diagnosis system according to an embodiment of the present disclosure may include a data measuring unit configured to acquire vibration data from a rotating body of a power generation facility; a signal processing unit configured to extract and quantify a certain characteristic factor for the time domain, frequency domain, and shape area by signal-processing the acquired vibration data; a characteristic pattern storage unit configured to store patterns of characteristic factors classified by failure type; and a failure diagnosis unit configured to diagnose whether the power generation facility to be diagnosed has a failure or the failure type of the power generation facility based on the patterns of classified characteristic factors.

For example, the data measuring unit includes a gap sensor that measures the vibration displacement of the rotating body and a taco sensor that measures the number of rotations of the rotating body to provide a reference point for each rotation.

The signal processing unit may process the signal so that vibration data is re-sampled on a constant angle basis for normal rotation. In addition, the signal processing unit may coordinate-axis transform the re-sampled vibration data into a predetermined unit of angle to obtain vibration data in each direction based on the circumferential direction of the rotating body.

For example, the characteristic factors in the time domain include at least one of the maximum value, effective value, average value, crest value, shape factor, impact coefficient, skewness, and kurtosis for vibration data, the characteristic factors in the shape area include an orbital shape long-short axis ratio for vibration data, and the characteristic factors in the frequency domain include at least one of FC (Frequency Center), RVF (Root Variance Frequency), RMSF (RMS Frequency), and the relative ratio of step frequency for vibration data.

The characteristic factors classified by the failure type are the optimal characteristics classified by the Kullback-Leibler Divergence or Probabilistic Discriminant Separability, using genetic algorithms for the characteristic factors derived from vibration data obtained from each failure type.

Here, the failure type includes at least one of the following states: mass unbalance, rubbing, misalignment and oil whirl states for the rotating body.

In addition, for the classified characteristic factors, the distribution of the steady-state data of the target facility is assumed to be normal distribution through machine learning, and then the distribution of the normal data of similar facilities is scaled to be equal to the normal-state data of the actual target facility, and the automatic diagnosis accuracy can be improved by updating the previous characteristic factor data.

The automatic diagnosis system of a power generation facility according to one embodiment of the detailed description of the present disclosure may further include a failure prediction unit that analyzes the remaining healthy state of the power generation facility to be diagnosed by failure type, based on the failure index for the characteristic factors set by the failure type among the characteristic factors.

In addition, the automatic diagnosis system of a power generation facility according to one embodiment of the detailed description of the present disclosure may further include an output unit that outputs in multidimensional graph format using characteristic factors related to the current state of the power generation facility to be diagnosed.

On the other hand, the automatic diagnosis method of a power generation facility according to another embodiment of the detailed description of the present disclosure may include the steps of: acquiring vibration data from the rotating body of the power generation facility; extracting and quantifying predetermined characteristic factors for the time domain, frequency domain and shape area by processing the acquired vibration data; classifying and storing patterns of the characteristic factors by failure type; and diagnosing whether the power generation facility to be diagnosed has a failure and failure type of the power generation facility, based on the pattern of the classified characteristic factor.

### Advantageous Effect

According to the detailed description of the present disclosure, it is possible to automatically determine whether the power generation facility has a failure and the failure type of the power generation facility by the vibration signal of the rotating body, and further, to predict an abnormal state of the power generation facility.

### BRIEF DESCRIPTION OF THE DRAWINGS

FIG. 1 is a diagram illustrating an automatic diagnosis system of a power generation facility in accordance with the detailed description of the present disclosure.

FIG. 2 is an exemplary view illustrating a rotating body supporting structure.

FIG. 3 is an exemplary view illustrating the process of pre-treatment process of re-sampling waveform data at a given angle, in which FIG. 3(a) shows a reference signal measured by a taco sensor, FIG. 3(b) shows the vibration signal measured by a gap sensor, and FIG. 3(c) shows the signal re-sampled by the signal processing unit.

FIG. 4(a) illustrates the vibration signal measured by a first vibration sensor, and FIG. 4(b) illustrates the vibration signal measured by a second vibration sensor, and FIG. 4(c) illustrates the vibration signal obtained by means of the coordinate axis transformation.

FIG. 5 is a graph for explaining the rotation of the coordinate axis.

FIGS. 6 (a) and (b) are graphs showing the rotation of the coordinate axis in the x-axis and y-axis directions, respectively.

FIG. 7 is a diagram illustrating interrelationships between the classes through probability distribution chart of vibration data in different situations.

FIG. 8 is a flow chart illustrating the process of selecting the optimal characteristic factors through the PDS separation techniques.

FIG. 9 is a flow chart illustrating the process of selecting the optimal characteristic factors through KLD separation techniques.

FIG. 10 is an exemplary view illustrating the process of applying the learning data scaling techniques.

FIG. 11 are exemplary views of the process of creating new learning data using data obtained from the power generation facility, in which FIG. 11(a) shows the Skewness distribution extracted from vibration signals of the target facility to be actually applied, FIG. 11(b) shows the Skewness distribution extracted from similar facilities in a normal state, and FIG. 11(c) shows the Sknewness distribution extracted from similar facilities in a normal steady state.

FIG. 12 is an exemplary view illustrating the consequences of changes due to scaling.

FIG. 13 is an exemplary view illustrating the current state of the power generation facility in a multi-dimensional graph using characteristic factors.

FIG. 14 is an exemplary view illustrating an automatic abnormal condition diagnostic screen based on the rotating body vibration interface module.

FIG. 15 is a flow chart showing the automatic diagnosis method of the power generation facility according to the detailed description of the disclosure.

FIG. 16 is a flow chart illustrating the vibration data-based machine learning flow and the automatic diagnosis process.

FIG. 17 is a flow chart illustrating the process of automatic prediction of vibration data-based failure conditions.

### MODES FOR CARRYING OUT THE PREFERRED EMBODIMENTS

Since the present disclosure can be modified into various forms and have various embodiments, specific embodiments will be illustrated in the drawings and detailed description thereof will be given. It should be understood, however, that the disclosure is not intended to be limited to the specific embodiments, but includes all conversions, equivalents, and alternatives falling within the spirit and scope of the disclosure. In describing the present disclosure, if a detailed explanation for a related known function or construction is considered to unnecessarily divert the gist of the present disclosure, such explanation has been omitted but would be understood by those skilled in the art.

The terms used in the present application are used only to describe certain embodiments and are not intended to limit the present disclosure. A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Description will now be given in detail according to preferred embodiments disclosed herein, with reference to the accompanying drawings. For the sake of brief description with reference to the drawings, the same or equivalent components may be provided with the same or similar reference numbers, and description thereof will not be repeated.

FIG. 1 is a diagram illustrating an automatic diagnosis system of a power generation facility in accordance with the detailed description of the present disclosure.

As shown in FIG. 1, the automatic diagnosis system in accordance with the present disclosure may include a measuring unit 10, a signal processing unit 20, a characteristic pattern storage unit 30, a failure diagnosing unit 40, a failure prediction unit 60, an output unit 70, and a controller 50.

First, the data measuring unit 10 has a configuration in which vibration data is acquired from the rotating body of the power generation facility.

The data measuring unit 10 may include, for example, a gap sensor that measures the vibration displacement of the rotating body and a taco sensor that measures the number of rotations of the rotating body as a key phaser to provide a reference point for each rotation.

As shown in FIG. 2, for example, the main equipment, such as a steam turbine at a power plant, has a structure that supports the two axes of a rotating body 13 with a bearing 15. Accordingly, the vibration displacement of the rotary shaft at the bearing 15 is measured for measuring the vibration of the rotating body 13 through the gap sensors 11, which is a contactless vibration sensor, and the contactless vibration sensor 11 may be mounted at 90° intervals at each measuring position of the bearing. In addition, the operational rotation of the rotating body of the main equipment of the domestic plant in a normal operation state is typically 3,600 RPM, and for optimum diagnosis in the time and frequency domains, the vibration data measurement sampling rate is measured by applying 3,200 samples/sec or more.

The signal processing unit 20 has a configuration in which the acquired vibration data is processed to extract and quantify predetermined characteristic factors for the time domain, frequency domain, and shape area.

The signal processing unit 20 may process signals to re-sample vibration data on a constant angle basis for normal rotation.

In the detailed description of the present disclosure, the re-sampling process based on the constant angle for the normal number of rotations of rotating body is a data pre-processing process that performs rotation angle-based re-sampling while classifying data by the number of rotations using the reference signal (i.e., the key phaser signal) that is the reference signal for each rotation. This data pre-processing process, for example, re-samples vibration signals synchronized with the rotation signals at the signal processing unit to acquire 128 digital signals at a fixed interval per one rotation. This data pre-processing process allows data from the rotation angle reference of each oscillating waveform to be extracted, eliminating the uncertainty that may arise from the speed difference and increasing the abnormal state-specific characteristics. The reference signal vibrating once per rotation, as shown in FIG. 3(a), not only informs the speed of the rotating body, but also serves as an absolute reference for the entire vibration signal, as shown in FIG. 3(b). Even normal plant turbines may be misanalyzed when the acquired vibration data is used in the same way, since the rotational speed varies slightly due to the synchronization of the system. Therefore, the signal sampling is performed based on a constant angle under normal operation load conditions to minimize the effects of rotational speed. As shown in FIG. 3(c), re-sampling all vibration data based on the reference signal to the same number of intervals per rotation results in the same information from the oscillating waveform as the rotational speed varies. In addition, data can be separated by the correct number of rotations, enabling character factor extraction that can further enhance the physical meaning. In addition, the data distribution can be reduced by re-sampling, which can have the effect of increasing the classification possibility.

The signal processing unit can then transform in coordinate-axis the re-sampled vibration data into a predetermined angular unit to acquire vibration data in each direction based on the circumferential direction of the rotating body.

Since the conventional diagnosis methods use only measured data from each sensor for diagnosis, the coordinate axis rotational transformation in the detailed description of the present disclosure is an important factor for enhancing diagnostic accuracy and robustness. Considering existing vibration size based diagnosis or data-based state diagnosis systems, maximum vibration at the measurement sensor position is not always possible, or data at the measurement position can represent all of its abnormal state characteristics.

In the present disclosure, data acquired by sensors (i.e., gap sensors) that form a radius of 90° for each bearing position can be used to recreate data in the direction in which no measurements are made. By considering the characteristics of each abnormal state in all circumferential directions of the rotating body, it can contribute to standardization of diagnostic performance and improved accuracy. For example, as shown in FIG. 4, vibration data from x-axis direction (a), y-axis direction (b), and coordinate axis rotation direction (c) can be obtained from vibration data of other characteristics that can occur from abnormal conditions.

In the case of journal bearings, there is a directional abnormality, which, by nature, does not affect the other direction. This directional abnormality is difficult to achieve an accurate diagnosis when the direction of the abnormality does not match the direction of the sensor. The method of diagnosis so far has not taken into account orientation at all.

In the present disclosure, the data measured from two vibration sensors forming 90 degrees are rotational transformed to the circumferential direction and converted to vibration signals in all directions. For example, as shown in FIG. 5, rotating the coordinate axis by 6 can define the new coordinates by equation 1 and obtain vibration signals for any direction.

$$[ \begin{matrix}{x}^{′} \\ {y}^{′}\end{matrix} ] = [ \begin{matrix}cos θ & sin θ \\ - sin θ & cos θ\end{matrix} ] = [ \begin{matrix}x \\ y\end{matrix} ] \qquad [ Equation 1 ]$$

FIG. 6 shows data specified by two sensors, which are disposed at 90 degrees for a particular abnormal condition acquired from journal bearings, and data obtained through coordinate axis rotation transformation. The data in the upper left corner of FIGS. 6 (a) and (b) are original data measured through contactless vibration sensors in the direction of x and y-axes, respectively, and the rest are data with a clockwise coordinate axis rotation transformation of 22.5 degrees. It can be seen that the data is symmetrical in relation to 180 degrees, and the data in the dotted line can be seen to be equal to the x-axis data by coordinate-axis rotating the y-axis data by 90 degrees.

In the present disclosure, data with which 11.25 degrees coordinate axis rotation transformation is applied is used, and this can reflect the overall vibration characteristics of the abnormal conditions to be explained later. After the re-sampling signal is processed, 16 rotations are made based on 11.25 degrees to obtain a 180 degree vibration signal. The remaining 180 degree range is duplicated because it is in the shape that changed the top and bottom of the original waveform. Therefore, vibration signals corresponding to 180 degrees are extracted at intervals of 11.25 degrees to obtain the data.

The vibration signal based characteristic factors are then extracted. Characteristic factors are extracted and quantified from regenerative data to enable automatic state diagnosis using regenerated data of vibration signals taking into account abnormal state orientation through the treatment of processing the re-sampled waveform data based on a constant angle to normal number of rotations and the rotational transformation of the coordinate axis.

As shown in Table 1, vibration signals are acquired as a waveform for time in the present disclosure, so first, to quantify the physical meaning of the rotating body into the time domain, factors related to the energy of the rotating body, i.e., Max, Mean, RMS (Root Mean Square), factors related to the shape of the oscillating waveform, i.e., Crest Factor, Shape Factor, and impulse Factor, and factors related to data distribution, i.e., Skewness and Kurtosis, and the like are selected. This allows the physical meaning for a given period of time to be seen. Factors, i.e., FC (Frequency Center), RVF (Root Variance Frequency), and RMSF (RMS Frequency) suitable for journal bearing systems among frequency domain factors are selected, and a shape area that was not traditionally present is introduced in the present disclosure. The shape area is a quantified value of the axial behavior form of the 1X vibration of the rotating body. Thus, the characteristic factors of the shape area as well as the time domain and frequency domain are all quantified with the vibration data.

TABLE 1

| Item | Vibration signal based characteristic factor | | | |
|---|---|---|---|---|
| Time domain | Max | max \|xᵢ\| | RMS | $\sqrt{{\sum }_{i = 1}^{N} {( x )}^{2} \text{/} N}$ |
| | Mean(abs) | $\frac{1}{N} {\sum }_{i = 1}^{N} \vert {x}_{i} \vert$ | Crest Factor | Max/RMS |
| | Shape Factor | RMS/Mean | Impulse Factor | Max/Mean |
| | Skewness | ${\sum }_{i = 1}^{N} {( {x}_{i} - \overline{x} )}^{3} \text{/} ( N - 1 ) {s}^{3}$ | Kurtosis | ${\sum }_{i = 1}^{N} {( {x}_{i} - \overline{x} )}^{4} \text{/} ( N - 1 ) {s}^{4}$ |
| Shape | Orbit | Orbital shape | | |
| area | aspect | long-short axis ratio | | |
| | ratio | | | |
| Frequency domain | Frequency center (FC) | $FC = \frac{{\int }_{0}^{∞} fs ( f ) df}{{\int }_{0}^{∞} s ( f ) df}$ | Root Variance Frequency (RVF) | $RVF = {[ \frac{{\int }_{0}^{∞} {( f - FC )}^{2} s ( f ) df}{{\int }_{0}^{∞} s ( f ) df} ]}^{\frac{1}{2}}$ |
| | RMS Frequency (RMSF) | $RMSF = {[ \frac{{\int }_{0}^{∞} {f}^{2} s ( f ) df}{{\int }_{0}^{∞} s ( f ) df} ]}^{\frac{1}{2}}$ | | |
| | Frequency relative ratio 1 | 0.5x/1x | Frequency relative ratio 6 | (0.51x~0.99x)/1x |
| | Frequency relative ratio 2 | 2x/1x | Frequency relative ratio 7 | (3x~5x)/1x |
| | Frequency relative ratio 3 | (2x~10x)/1x | Frequency relative ratio 8 | (3x, 5x, 7x, 9x)/1x |
| | Frequency relative ratio 4 | (0~0.39x)/1x | Frequency relative ratio 9 | (Total-1x)/1x |
| | Frequency relative ratio 5 | (0.4x~0.49x)/1x | | |

Where x is the number of rotations, N is the total number of rotations, and s is the degree of skewness.

The time domain contains elements that each waveform shows remarkable features, so the information obtained from one rotation is useful. For the shape area, the trajectory shape of each bearing corresponding to 1X from one rotation is used for the length of the long axis and the short axis. On the other hand, it is advantageous to extract characteristic factors based on the number of rotations as much as possible because the frequency domain represents the physical force from vibration data for a period of time. However, it is necessary to select an appropriate number of rotations because the amount of data available will decrease if the waveform is based on too many rotations. In the present disclosure, 60 rotations are used, taking into account the rotation of the frequency response function, and one rotation in the time domain and shape area.

Subsequently, the characteristic pattern storage unit 30 has a configuration in which patterns of characteristic factors classified by failure type are stored. For example, the characteristic factors classified for each failure type are the optimal characteristic factors classified by the KLD (Kullback-Leibler Divergence) or PDS (Probabilistic Discriminant Separability), using the genetic algorithm with respect to the characteristic factors extracted from the vibration data from each failure type. Here, the failure type includes at least one of the following states: mass unbalanced, rubbing, misaligned and oil whirl states for the rotating body.

The selection of one rotation-based reference characteristic factors in the time domain and 60 rotations-based reference characteristic factors in the frequency domain is due to their superior classification ability. The first criterion indicating the separability between data groups applied in the present disclosure is the Mutual Information, which is the KDL (Koolback-Liebler Divergence).

$$MI ( X ; Y ) = {\sum }_{y ∈ Y} {\sum }_{x ∈ X} p ( x , y ) log ( \frac{p ( x , y )}{p ( x ) p ( y )} ) = {D}_{K L} ( p ( x , y ) ‖ p ( x ) p ( y ) ) \qquad [ Equation 2 ]$$

Here, X and Y are characteristic factors. D KL (P∥Q) is a relative entropy.

This shows similar result to that of the FDR (Fisher Discriminant Ratio) techniques that applies Equation 3.

$$F D R = \frac{{μ}_{i} - {μ}_{j}}{{σ}_{i} - {σ}_{j}} \qquad [ Equation 3 ]$$

Here μ represents the mean value and σ represents the standard deviation.

The criteria for the second set of data to be applied in the present disclosure are defined by a new criterion, known as the PDS (Probabilistic Discriminant Separability), as in Equation 4.

FDS=∫_{∞}^{∞}F_{c1}(x)F_{c2}(x)dx,\tilde{x}_{c1}≤\tilde{x}_{c2} [Equation 4]

Here f_{c1} and f_{c2} represents the cumulative distribution function of class 1 and the probability density function of class 2 among the data groups respectively.

\tilde{x}_{c1}

and

\tilde{x}x_{c2}

are the median values of each class. The PDS equation of the probabilistic separation determination in which the probability of non-separation domain is between 0 and 0.5 can be defined as the normalized classification value between 0 and 1, as expressed in Equation 5.

PDS=(e^{(1-2×P}^{_{NS}}⁾−1)/(e−1) [Equation 5]

Thus, as shown in FIG. 7, the probability distribution chart of the two classes of data in different situations was shown. In FIG. 7, two or more states (Class 1, Class 2) are distributed overlapping so that conditions difficult to classify is presented in grey. Meanwhile, Table 2 shows the quantification made by KLD techniques, FDR techniques and PDS techniques for FIGS. 7(a) through 7(d). Of the three techniques, PDS is the application of the principle of obtaining reliability based on strength and load in reliability analysis theory. This type of techniques is the criteria for data classification ability, which designates a high level of classification ability without overlapping parts as 1 and a non-capability of classification with full overlapping parts as 0, by quantifying the overlapped part from the probability distribution chart of the two classes of the data. The PDS techniques, like KLD techniques and FDR techniques, are based on binary classification but have the advantage of averaging each case to compare among individual characteristic factors.

TABLE 2

| Itme | (a) | (b) | (c) | (d) |
|---|---|---|---|---|
| KLD | 0 | 10.993 | 46.449 | 56.942 |
| FDR | 0 | 2.004 | 8.017 | 40.584 |
| PDS | 0 | 0.399 | 0.849 | 1 |

The characteristic factors by each abnormal condition extracted from vibration data (including coordinate axis rotary transformation data) obtained from each abnormal state are considered to be one class and the classifier is studied by machine learning method. The learning of the classifier used in the present disclosure selects the optimum characteristic through the selection process, as shown in FIG. 8, before proceeding. Alternatively, the optimal characteristic factors may be selected using the same genetic algorithm as in FIG. 9 by applying the PDS (Probabilistic Separation Discriminant) of Equation 5 to the following Equation 6 to remove the characteristic factors having correlation coefficients (p,j,l) between the characteristic factors of the j-th and l-th of m characteristic factors.

$$Maximize π = \frac{1}{m} {\sum }_{j = 1}^{m} P D {S}_{j} - \frac{1}{{mc}_{2}} {\sum }_{j \neq 1}^{m} \vert p , i , l \vert \qquad [ Equation 6 ]$$

The classifier is learned using characteristic factors obtained from the analysis of the constant angle reference re-sampling and coordinate axis rotation transformation, and in the domains of time and frequency in the vibration data for learning of each abnormal condition acquired through the power generation equipments or test bed. In the present disclosure, the genetic algorithm (GA) is used to select highly sensitive characteristics such as in FIG. 8 to classify failure types without distortion, and the classifier is also a classifier learning module to which the machine learning method such as the FDR (Fisher Discriminant Ratio) which is a linear discrimination method and the SVM (Support Vector Machine) suitable for both linear and nonlinear analysis method may be applied, as shown in FIG. 9. The support vector machine uses kernel functions such as Liner, Polynomial, and RBF. Here the kernel function as a similarity function plays a role to move the data to a higher dimension, thereby increasing the accuracy of the data classification.

The criteria for scaling are then implemented by comparing and analyzing the normal state data of the actual facilities and the normal state data of the similar facilities. After the distribution of data is assumed to be normal, the distribution of steady-state data obtained from similar facilities is scaled to the same as those obtained from the actual target facility, as shown in Equation 7. In schematic terms, it can be shown in FIG. 10. Scaling criteria are defined from normal data, and include scaling the entire learning data of existing similar facilities to use as new learning data.

$${X}_{t , i}^{′} = \frac{{σ}_{p , i}}{{σ}_{t 1 , i}} {X}_{t , i} - \frac{{σ}_{p , i}}{{σ}_{t 1 , i}} {μ}_{t 1 , i} + {μ}_{p , i} \qquad [ Equation 7 ]$$

Here,

i: ith integrity data

Xt: existing learning data

X′t: new learning data

Mt1: average of normal state among existing learning data

σt1: standard deviation of normal state among existing learning data

μp: average of actual system data

σp: standard deviation of actual system data

In the present disclosure, the data-based diagnostic algorithm basically includes a method to scale and utilize existing learning data obtained through a similar facility based on the normal data obtained from the actual facility so that even if the entire specification, such as size, is applied through a similar facility with different abnormal conditions compared to the actual target facility, to ensure diagnostic accuracy.

Consecutively, the failure diagnosis unit 40 is an automatic diagnostic module that diagnoses whether the power generation system to be diagnosed has a failure and the failure type of the power generation facility, based on the pattern of the classified characteristic factors.

The automatic diagnosis module is a module that automatically diagnoses whether vibration during the current operation has characteristics close to any abnormal state by using information from a machine-learned classifier through a classifier learning module. Automatic diagnosis process of abnormal condition is done by comparing the calculated characteristic factors operated through the pre-treatment preprocess with the reference parameters by data classification techniques derived by transmitting them as input variables to the machine-learned classifier to statistically determine where the status of the real-time vibration signal is, and then calculating and diagnosing the failure type (Anomaly Probability) which is the fault information for the rotating body bearing condition, such as normal, unbalance, rubbing, misalign and oil whirl, using the automatically learned SVM or the FDA classifier, as shown in FIG. 8.

$$A {P}_{j} = \frac{1}{N} {\sum }_{i = 1}^{N} \{ \frac{1}{{D}_{j , i}} / {\sum }_{k = 1}^{M} ( 1 / {D}_{k , i} ) \} \qquad [ Equation 8 ]$$

Here, Dj,i is the value calculated by FDA or VSM of the j-th class in the i-th coordinate axis rotation transformation (ODR: Omni Directional Regeneration).

Subsequently, the output unit 70 has a configuration that outputs in a multi-dimensional graph form using characteristic factors related to the current state of the power generation facility to be diagnosed. In the present disclosure, the original data is transformed using PCA (Principal Component Analysis) techniques to visualize the abnormal state class by failure type using the characteristic factors selected in the classifier learning module. By applying the selected characteristic factors from the learning data to the PCA techniques as input variables, the transformation method can extract PCA coefficients and produce the transformed data through these coefficients and the matrix product of the learned classifiers, the learning information of the classifiers learned for diagnosis can be visualized as shown in FIG. 13. In FIG. 13, D1, D2, D3 and D4 indicate the values produced by the SVM classifier using multidimensional characteristic factors (HD1, HD2 and HD3). In addition, the output unit 70 may determine and predict the failure and abnormalities for each measuring part of the power generation facility using vibration data, as shown in FIG. 14, and the current condition of the power generation facility may be identified in graph form. In the graph to the right of FIG. 14, the x-axis is about the ratio of the orbital long and short axis, the y-axis is about the waveform asymmetry (i.e., skewness), and the z-axis is about the application of the vibration peak value (max(abs). According to these methods, the current status of normal, unbalance, rubbing, misalign and oil whirl can be checked through the relevant characteristic factors.

In summary, as shown in FIG. 16, the machine learning is performed by, for example, extracting characteristic factors by the failure type from abnormality symptom and failure vibration waveforms in advance, selecting and storing optimal characteristic factors based on mutual information volume in the data base (i.e., the characteristic pattern storage unit). This process is repeated for classifier-based machine learning. On the other hand, when real-time vibration data is measured from the power generation facility to be diagnosed, the failure is diagnosed based on the optimal characteristic factor by extracting the characteristics (i.e., character factor extraction) and the current condition is evaluated.

The failure prediction unit 60, a condition prediction support module, analyzes the remaining healthy state of the power generation facility to be diagnosed by failure type, based on the failure index for the characteristic factors set by failure type.

The failure prediction unit 60 receives a real-time failure index (AI: Anomaly Index) from the failure diagnosis unit 40, generates a model that can estimate the probability of failure for each type of rotating body failure, and provides quantified information on the remaining healthy state (RHS). The failure index (AI) may be defined by types, as shown in Table 3.

TABLE 3

| State types | | |
|---|---|---|
| of rotating | | |
| body facility | Definition of healthy factor | Remarks |
| Unbalance | $\frac{max ( max vib )}{clearance}$ | Clearance: Maximum vibration allowable value (or conservative gap between bearing and shaft) Max vib: Biggest vibration numerical value |
| | | characteristic factor in 1 cycle of vibration signal |
| Rubbing | 1-(Orbit Aspect Ratio of 1X) | Orbit aspect ratio characteristic factor |
| Misalignment | 1-(Orbit Aspect Ratio of 1X) × 0.9 | Orbit aspect ratio characteristic factor |
| Oil whirl | 0.4-0.49X/1X | Frequency relative ratio5 characteristic factor |

The characteristics of the failure prediction unit 60 are to add the basic model generated based on historical data from the normal operating section of the power generation facility and the AI (anomaly index) data group (a number of which can be set by users) which is transmitted in real time to the historical data used to create the basic model, to determine the degree of change in existing distribution through the Bayesian inference process, thereby creating the variable model. When the left-to-right domain limit of a user-set distribution chart is exceeded, the corresponding failure-type basic model creates an additional variable-type model and continues to dynamically and automatically analyze the model trend. For example, the failure prediction process is as shown in FIG. 17. In this instance, the average and standard deviation of the post-distribution chart are used, as shown in the Equation 9.

$$\hat{u} = \frac{M {τ}^{2} \overline{x} + {σ}^{2} u}{M {τ}^{2} + {σ}^{2}} , {\hat{τ}}^{2} = {( \frac{M}{{σ}^{2}} + \frac{1}{{τ}^{2}} )}^{- 1} = \frac{{σ}^{2} {τ}^{2}}{M {σ}^{2} + {σ}^{2}} \qquad [ Equation 9 ]$$

Here, M is a number of data,

X̅ is an average of M, σ is a standard deviation,

Ū is an average of post distribution chart, and

τ̅ is a standard deviation of post distribution chart.

The meaning of generation of a variable model is that AI data characteristics change based on normal state as facility conditions deteriorate and change, and the analysis point slope can be steeped or relaxed as constant values of the exponential function used in the basic model change mathematically. This is the principle of predicting facility conditions in advance through changes in the trend of the variable model by allowing visual observation of remaining healthy state (RHS) changes.

For example, normal and unbalance conditions in a rotating body vibration have similar characteristics, so even if unbalance is produced through the data classifier, the results are not immediately determined, and the normal state of the anomaly index (AI) defined by the algorithm is defined as an unbalance state only when the user-set limit is exceeded (when the limit is not exceeded, the result corresponding to the normal state is used). The remaining failure types can be used to diagnose bearing conditions by trusting the final results of the data classifier.

The controller 50 is configured to control the data measuring unit 10, the signal processing unit 20, the characteristic pattern storage unit 30, the failure diagnosis unit 40, the failure prediction unit 60, and the output unit 70.

According to the present disclosure, not only can it be used as an automatic diagnosis device for abnormal conditions of power generation facilities such as a steam turbine, gas turbine, pump, etc. based on the interface module for diagnosis, using the buffered output of the existing site monitoring device, but it can also be used as a system for detecting abnormal conditions in remote locations through various communication methods and for detecting abnormal conditions of facilities in advance and applying it as an abnormal state monitoring and failure diagnosis systems in connection with the big data processing base.

Then, as shown in FIG. 15, description will be given of the automatic diagnosis method of power generation facilities in accordance with the present disclosure.

As shown in FIG. 15, the automatic diagnosis method of power generation facilities in accordance with the present disclosure is to obtain vibration data from the rotating body of the power generation facility (S10). Then, the acquired vibration data is processed by signal processing, extracting and quantifying a certain characteristic factor for the time domain, frequency domain, and shape area (S20). Subsequently, the pattern of characteristic factors is classified and stored by each failure type (S30). Thereafter, based on the pattern of the classified characteristic factors, whether the power generation facility to be diagnosed has a failure and the failure type of the power generation facility (S40) are diagnosed.

According to the present disclosure, a model may be created for the core rotating body facility of the thermal power plant to calculate the healthy factors of each failure type in real time, quantify them, and track the timing of failure in response to the vibration signals acquired during operation. In addition, by applying these models to the plant site, abnormal state changes may be communicated to the plant staff without distortion to improve accident reduction and safety of the associated facilities.

In the present disclosure, the key phaser signals that have not been measured so far should be included, and vibration signals should be acquired at a higher sampling rate. These may be used as guidelines for building databases. In an actual operation of the plant, the same facility exhibits different features and the rotational speed also changes continuously. In addition, it is important to obtain consistent vibration data in various environments as unstable vibration signals often occur due to sudden failures. In the present disclosure, vibration data is re-sampled at each rotation as an absolute criterion of the key phaser signal, regardless of the speed of rotation, and based on this, characteristic factors are extracted from the time domain, frequency domain and shape area. Because characteristic factors are extracted based on the number of rotations, consistent analysis is possible even with sudden changes in the vibration signal. In addition, directional data generation and abnormal condition diagnosis are possible, which can increase diagnostic accuracy and robustness.

In addition, conventional diagnosis systems use only measured signals. However, the diagnosis should be made considering all signals in a circumferential direction, as conditions may occur more than any other way even if the sensor is not present. According to the present disclosure, a circumferential vibration signal at intervals of approximately 10° can be obtained, thus diagnosing a directional abnormal condition. The robustness of diagnosis is increased by establishing a rotational number criterion suitable for extracting characteristic factors in the time domain and frequency domain. Considering each characteristic, the characteristic factors of the time domain is extracted on one (1) rotation basis and the characteristic factors of the frequency domain on sixty (60) rotations basis. In addition, the characteristic factors suitable for the plant journal bearing system are selected, and each selected characteristic factor is utilized as an important factor with physical meaning. The characteristic factors used, in addition to the existing classification capability evaluation methods (KLD and FDR), are also shown by PDS to be superior to those of other criteria. A new classification capability evaluation standard called PDS has been found. Until now, the evaluation criteria that represent the capability to classify are mostly relative indicators, and comparisons between characteristic factors have been difficult. However, PDS can all be expressed as a value between 0 and 1 by getting ideas from reliability analysis theory. Thus, PDS allows quantitative definition of the capability of two types of data to be classified.

The scope of the present disclosure is very wide as it can be applied to power plants such as nuclear power, thermal power and hydro, as well as failed automatic diagnosis of key journal bearing rotary facilities such as various chemical plants, oil facilities and factories. Up to now, the operation of a device capable of self-diagnosing failures or abnormalities, even in the latest large-scale power plants, has formed a market by the rule engine or early warning concept, but the present disclosure is directed to a revolutionary technology to automatically diagnose major abnormal conditions of the rotating body by reflecting the methods that define and extract the characteristic factors in the time domain, shape area, and frequency domain through pre-treatment process of a constant angle based re-sampling waveform data, and the physical characteristics such as the rubbing, unbalance, misalign, oil whirl, etc., which are classified as a failure of rotational vibration.

Even when it is described that all components of embodiments of the present disclosure are combined into one or operate in combination with each other, it is understood that the present disclosure is not limited to the above-mentioned embodiments. That is, within the scope of the purpose of the present disclosure, one or more of all the components may be selectively combined with each other to operate. In addition, although all of the components may be implemented as one piece of independent hardware, some or all of the components may be selectively combined to be thereby implemented as a computer program having a program module that performs some or all of functions combined in one or a plurality of pieces of hardware. Codes, and code segments constituting the computer program can be easily construed by one of ordinary skill in the art to which the present disclosure belongs. Such a computer program may be stored in computer-readable storage media, readable and executed by a computer, to thereby implement embodiments of the present disclosure. Examples of the computer-readable storage media include magnetic storage medium, optical recording media, and storage media such as carrier waves.

It will be further understood that the terms “comprises,” “comprising,” “includes,” and/or “including,” when used herein, specify the presence of components, but do not preclude the presence or addition of one or more other components, unless otherwise specified. Unless otherwise defined, all terms including technical and scientific terms used herein may be used as having a meaning that can be understood in common by one of ordinary skill in the art. A general term that is defined in a generally used dictionary are interpreted as having a meaning consistent with the contextual meaning of the related art and are not interpreted ideally or excessively, unless otherwise defined explicitly and particularly.

The foregoing description of the technical scope of the present disclosure is merely illustrative, and it will be apparent to those skilled in the art that various modifications and changes can be made in the present disclosure without departing from the spirit and scope of the disclosure as defined by the appended claims. Therefore, the embodiments disclosed in the present disclosure should be considered in a descriptive sense only and not for purposes of limitation. The scope of the technical idea of the present disclosure is not limited by these embodiments. The scope of the present disclosure is defined by the appended claims provided below, and all concepts within the scope will be construed as being included in the present disclosure.

1. An automatic diagnosis system of a power generation facility comprising:
a data measuring unit configured to acquire vibration data from a rotating body of a power generation facility;
a signal processing unit configured to extract and quantify a certain characteristic factor for the time domain, frequency domain, and shape area by signal-processing the acquired vibration data;
a characteristic pattern storage unit configured to store patterns of characteristic factors classified by failure type; and
a failure diagnosis unit configured to diagnose whether the power generation facility to be diagnosed has a failure and the failure type of the power generation facility, based on patterns of the classified characteristic factors.

2. The system of claim 1, wherein the data measuring unit includes a gap sensor that measures the vibration displacement of the rotating body and a taco sensor that measures the number of rotations of the rotating body to provide a reference point for each rotation.

3. The system of claim 1, wherein the signal processing unit is configured to process the signal to re-sample the vibration data on a constant angle basis for normal rotation.

4. The system of claim 3, wherein the signal processing unit is configured to coordinate-axis transform the re-sampled vibration data at a predetermined unit of angle to obtain vibration data in each direction based on the circumferential direction of the rotating body.

5. The system of claim 1, wherein the characteristic factors in the time domain include at least one of the maximum value, effective value, average value, crest value, shape factor, impact coefficient, skewness, and kurtosis for vibration data,
wherein the characteristic factors in the shape area include an orbital shape long-short axis ratio for vibration data, and
wherein the characteristic factors in the frequency domain include at least one of FC (Frequency Center), RVF (Root Variance Frequency), RMSF (RMS Frequency), and the relative ratio of step frequency for vibration data.

6. The system of claim 1, wherein the characteristic factors classified by the failure types are the optimal characteristics classified by the Kullback-Leibler Divergence or Probabilistic Discriminant Separability, using genetic algorithms for the characteristic factors extracted from vibration data obtained from each failure type.

7. The system of claim 1, wherein the failure type includes at least one of a mass unbalance state, a rubbing state, a misalignment state and an oil whirl state for the rotating body.

8. The system of claim 1, wherein, for the classified characteristic factors, the distribution of the normal-state data of the target facility is assumed to be normal distribution through the machine learning, and the distribution of the normal data of similar facilities is scaled to be equal to the normal-state data of the actual target facility, to improve the automatic diagnosis accuracy by updating the previous characteristic factor data.

9. The system of claim 1, further comprising a failure prediction unit configured to analyze the remaining health state of the power generation facility to be diagnosed by the failure types, based on the failure index for the characteristic factors set by the failure types among the characteristic factors.

10. The system of claim 1, further comprising an output unit configured to output in multidimensional graph form using characteristic factors related to the current state of the power generation facility to be diagnosed.

11. An automatic diagnosis method of a power generation facility comprising:
acquiring vibration data from a rotating body of the power generation facility;
extracting and quantifying certain characteristic factors for the time domain, frequency domain and shape area by signal-processing the acquired vibration data;
classifying and storing patterns of the characteristic factors by failure type; and
diagnosing whether the power generation facility to be diagnosed has a failure and the failure type of the power generation facility, based on patterns of the classified characteristic factors.
